(19) United States
(12) Patent Application Publication
(10) Pub. No.: US 2009/0249307 A1
(43) Pub. Date: Oct. 1, 2009

(54) PROGRAM ANALYSIS APPARATUS, PROGRAM ANALYSIS METHOD, AND PROGRAM STORAGE MEDIUM

(75) Inventor: Mitsunobu Yoshida, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/407,333

(22) Filed: Mar. 19, 2009

(30) Foreign Application Priority Data
Mar. 26, 2008 (JP) 2008-81057

(51) Int. Cl. G06F 9/44

(52) U.S. Cl. 717/131

(57) ABSTRACT

There is provided with an apparatus which includes: an inputting unit which inputs a target program and address definition data, a first analyzer which generates definition-reference data associating a line number of a statement, an address of a definition variable and an address of a reference variable; a second analyzer which generates address dependency data that associates the address of the definition variable, the line number of a statement containing the definition variable, and the line number of a statement containing a reference variable of same address as the definition variable; a third analyzer which generates control dependency data that associates the line number of a control statement and the line number of a controlled-object statement; and an extracting unit which extracts a slice as a set of statements reached based on the control dependency data and the address dependency data starting from the statement of a desired line number.

### CROSS REFERENCE TO RELATED APPLICATIONS

This application is based upon and claims the benefit of priority from the prior Japanese Patent Applications No. 2008-81057, filed on Mar. 26, 2008; the entire contents of which are incorporated herein by reference.

### BACKGROUND OF THE INVENTION

1. Field of the Invention

The present invention relates to a program analysis apparatus, program analysis method, and program storage medium. The present invention relates to a technique for analyzing dependency relations between variables contained in a program, for example.

2. Related Art

Program slicing is a traditional technique to extract as a slice (a program fragment or a partial program) a set of statements that can affect or can be affected by a statement of interest in a target program.

Conventional program slicing pays attention to variable name to identify and extract statements that have dependency relations with each other. Thus, one problem associated is that, when there are one variable and another variable and those variables point to the same address, the variables are considered not to have a dependency relation with each other. Also, in a program that contains a union or the like, separate variables (i.e. member variables) are defined at the same address, and when one of the variables changes, all the other variables will change. Because each of such variables is handled as a separate variable, a slice cannot be correctly extracted in a program that contains a union or the like. A slice also cannot be correctly extracted in a program that contains arrays or pointers.

### SUMMARY OF THE INVENTION

According to an aspect of the present invention, there is provided with a program analysis apparatus, comprising:

an input unit configured to input
a target program which includes a plurality of statements described by using a plurality of variables and a plurality of operators, the statements each being provided with a line number for identifying each of the statements, each of the variables included in a part of or all of the statements being either a definition variable or a reference variable, and
address definition data which allocates an address to each of the variables;

a first analyzer configured to detect a definition variable and a reference variable in the statements, and generate, for each of the statements including at least one of the definition variable and the reference variable, definition-reference data which associates a line number of the statement, an address allocated to the definition variable included in the statement, and the address allocated to the reference variable included in the statement to each other;

a second analyzer configured to generate address dependency data that associates the address of the definition variable, the line number of the statement that contains the definition variable, and the line number of the statement that contains the reference variable assigned same address as the definition variable to each other, based on the definition-reference data;

a third analyzer configured to detect a control statement and a controlled-object statement which is executed depending on a result of executing the control statement in the target program, and generate control dependency data that associates the line number of the control statement and the line number of the controlled-object statement to each other;

a slicing criterion specifying unit configured to specify a desired line number of a statement in the target program as a slicing criterion; and
a slice extracting unit configured to extract a set of statements which are reached based on the control dependency data and the address dependency data starting from the statement of the desired line number, as a slice from the target program.

According to an aspect of the present invention, there is provided with a program analysis method performed in a computer apparatus including a computer readable storage medium containing a set of instructions that cause a computer processor to perform a data analyzing process, comprising:

inputting a target program which includes a plurality of statements described by using a plurality of variables and a plurality of operators, the statements each being provided with a line number for identifying each of the statements, each of the variables included in a part of or all of the statements being either a definition variable or a reference variable,

inputting address definition data which allocates an address to each of the variables;

detecting a definition variable and a reference variable in the statements, and generating, for each of the statements including at least one of the definition variable and the reference variable, definition-reference data which associates a line number of the statement, an address allocated to the definition variable included in the statement, and the address allocated to the reference variable included in the statement to each other;

generating address dependency data that associates the address of the definition variable, the line number of the statement that contains the definition variable, and the line number of the statement that contains the reference variable assigned same address as the definition variable to each other, based on the definition-reference data;

detecting a control statement and a controlled-object statement which is executed depending on a result of executing the control statement in the target program, and generating control dependency data that associates the line number of the control statement and the line number of the controlled-object statement to each other;

specifying a desired line number of a statement in the target program as a slicing criterion; and

extracting a set of statements which are reached based on the control dependency data and the address dependency data starting from the statement of the desired line number, as a slice from the target program.

According to an aspect of the present invention, there is provided with a program storage medium storing a computer program for causing a computer to execution instructions to perform the steps of:

inputting a target program which describes a plurality of statements by using a plurality of variables and a plurality of operators, the statements each being provided with a line number for identifying each of the statements, each of the variables included in a part of or all of the statements being either a definition variable or a reference variable,

inputting address definition data which allocates an address to each of the variables;

detecting a definition variable and a reference variable in the statements, and generating, for each of the statements including at least one of the definition variable and the reference variable, definition-reference data which associates a line number of the statement, an address allocated to the definition variable included in the statement, and the address allocated to the reference variable included in the statement to each other;

generating address dependency data that associates the address of the definition variable, the line number of the statement that contains the definition variable, and the line number of the statement that contains the reference variable assinged same address as the definition variable to each other, based on the definition-reference data;

detecting a control statement and a controlled-object statement which is executed depending on a result of executing the control statement in the target program, and generating control dependency data that associates the line number of the control statement and the line number of the controlled-object statement to each other;

specifying a desired line number of a statement in the target program as a slicing criterion; and

extracting a set of statements which are reached based on the control dependency data and the address dependency data starting from the statement of the desired line number, as a slice from the target program.

### BRIEF DESCRIPTION OF THE DRAWINGS

FIG. 1 is a functional block diagram of a program analysis apparatus according to a first embodiment;

FIG. 2 is a hardware block diagram showing a configuration of the program analysis apparatus according to the first embodiment;

FIG. 3 shows an example of an execution environment for a target program;

FIG. 4 shows an example of a syntax tree according to the first embodiment;

FIG. 5 shows another example of a syntax tree according to the first embodiment;

FIG. 6 is a flowchart illustrating the operational flow of an address definition-reference relation analyzer according to the first embodiment;

FIG. 7 shows an example of an inter-address definition reference table according to the first embodiment;

FIG. 8 is a flowchart illustrating the operational flow of an address dependency relation analyzer according to the first embodiment;

FIG. 9 is a flowchart illustrating the operational flow of a control dependency relation analyzer based on the first embodiment;

FIG. 10 is a flowchart illustrating an example of a program analysis method according to the first embodiment;

FIG. 11 shows an example of a syntax tree according to a second embodiment;

FIG. 12 shows an example of the inter-address definition-reference table according to the second embodiment;

FIG. 13 is a functional block diagram of the program analysis apparatus according to a third embodiment;

FIG. 14 shows an example of a syntax tree according to the third embodiment;

FIG. 15 shows an example of the inter-address definition-reference table according to the third embodiment;

FIG. 16 is a functional block diagram of the program analysis apparatus according to a fourth embodiment;

FIG. 17 is a functional block diagram of the program analysis apparatus according to a fifth embodiment;

FIG. 18 shows an example of a syntax tree according to the fifth embodiment;

FIG. 19 shows an example of the inter-address definition-reference table according to the fifth embodiment;

FIG. 20 shows the configuration of a conventional program analysis apparatus;

FIG. 21 shows an example of an inter-variable definition-reference table according to a conventional art;

FIG. 22 shows an example of an inter-variable definition-reference table according to the conventional art; and

FIG. 23 shows an example of a syntax tree according to the conventional art.

### DETAILED DESCRIPTION OF THE INVENTION

First, terms relating to program syntax which will be used in the following description are defined. This definition of terms is compliant with JIS X3010.

An “expression” is a sequence of operators and operands.

An “expression statement” is an expression with a semi-colon (;) or just a semi-colon (;).

“Declaration” is a syntax that specifies the attribute of an identifier (e.g. a variable).

A “statement” is a unit for defining operations to be executed, including iteration statement such as “for” and “while” statement, selection statement such as “switch” statement, labeled statement such as “case” statement, expression statement, compound statement that combines a plurality of statements or declarations into one statement, and branch statement such as “go-to” statement and “return” statement. Iteration statement, selection statement, labeled statement, and branch statement may be collectively called control statement.

In the following, a conventional way of program slicing which the inventors have known since before we conceived the present invention is described.

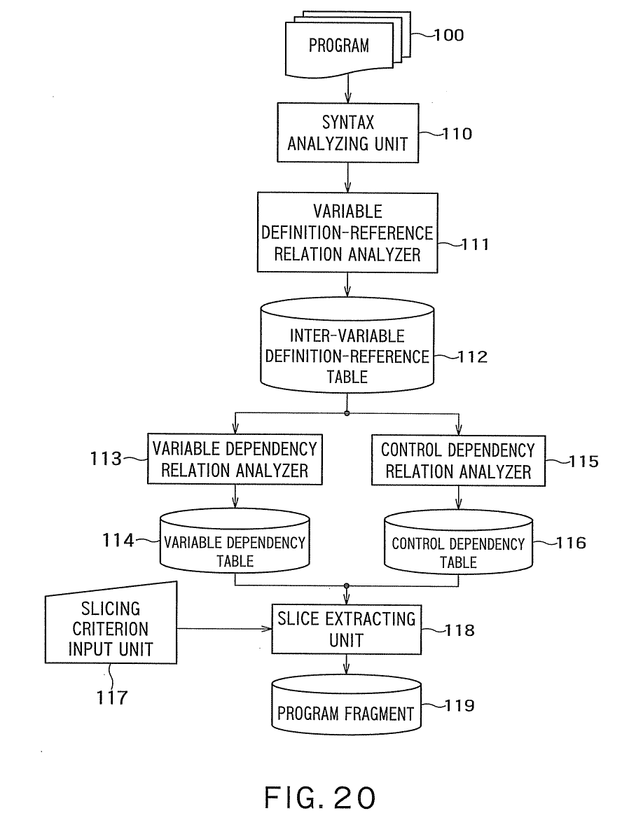

FIG. 20 shows the configuration of a conventional program analysis apparatus.

A syntax analyzing unit 110 reads a target program 100 described in text and performs syntax analysis on it. Syntax analysis is performed by analyzing a given character string according to syntax rules and determining whether it has a structure permissible in the target programming language (e.g., C language). More specifically, the target program 100 is first read in and subjected to lexical analysis for decomposing it into tokens, such as “=” and numerical values, and then it is evaluated whether the sequence of the tokens conforms to the grammar of the program. Finally, a labeled directed graph called a syntax tree is output. Operators are associated with the nodes of the syntax tree and operands with the leaves.

Suppose the following as the target program 100, for example:

[0-1]

L1: a = 10;
L2: b = a * 2;
L3: if( b > 10 ){
L4: c = a;
L5: d = b;
}

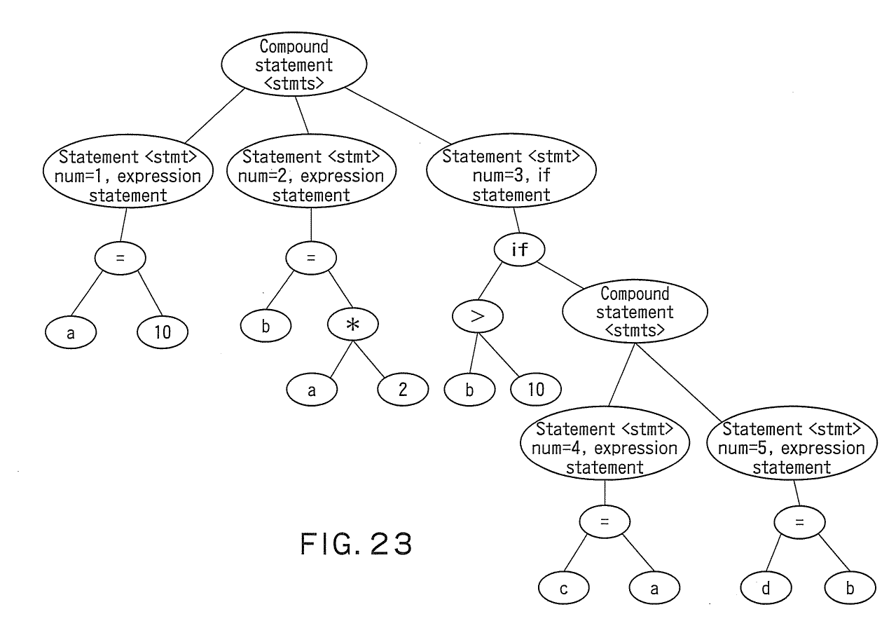

In this case, text notation of its syntax tree is as shown below and the structure of the syntax tree is as shown in FIG. 23. In the target program of [0-1], L1 to L5 denote line numbers. A detailed creation process of a syntax tree is discussed later.

[0-2]

```
L01:<stmts>
L02:  <stmt num=” 1” type=” exp” >
L03:  <node op=” =” ><I>a</I><r>10</r></node>
L04:  </stmt>
L05:  <stmt num=” 2” type=” exp” >
L06:  <node op=” =” ><I>b</I><r><node op=” *” >
        <I>a</I><r>2</r></node></r></node>
L07:  </stmt>
L08:  <stmt num=” 3” type=” if” >
L09:  <node>
L10:  <I><node op=” >” ><I>b</I><r>10</r></node></I>
L11:  <r><stmts>
L12:  <stmt num=” 4” type=” exp” >
            <node op=” =” ><I>c</I><r>a</r></node></stmt>
L13:  <stmt num=” 5” type=” exp” >
            <node op=” =” ><I>d</I><r>b</r></node></stmt>
L14:  </stmts></r>
L15:  </stmt>
L16:</stmts>
```

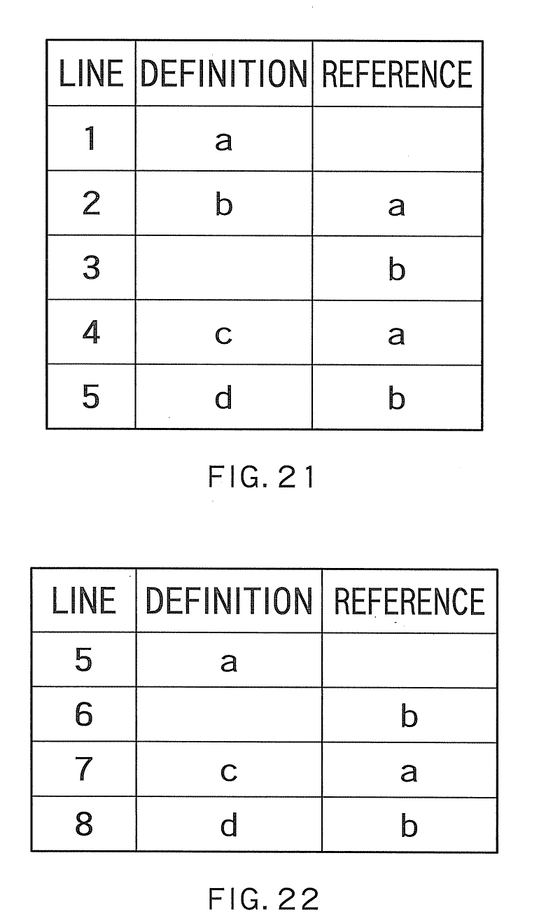

A variable definition-reference relation analyzer 111 reads expressions from the syntax tree on a line-by-line basis, extracts a variable on the left side of an assignment operator as a definition variable (or a definition part) and a variable on the right side of the assignment operator as a reference variable (or a reference part), and generates a inter-variable definition-reference table 112 which shows correspondence between the definition variable and the reference variable in association with a liner number. An example of the inter-variable definition-reference table 112 that is generated based on the syntax tree of [0-2] is shown in FIG. 21.

A variable dependency relation analyzer 113 generates a variable dependency table 114 based on the inter-variable definition-reference table 112. First, a definition variable defined in the inter-variable definition-reference table 112 is taken and a line number corresponding to the definition variable is stored. Then, a reference variable that corresponds with the name of the definition variable is detected, and a line number corresponding to the reference variable detected is stored. Then, the line number of the definition variable, the definition variable name, and the line number of the reference variable detected are made variable dependency relation data as a set, which is stored in the variable dependency table 114. Herein, a variable dependency relation is represented using a prefix of “DD”. For instance, when a variable “a” is defined in line number 1 and is referenced in line number 2, variable dependency relation is represented as: DD(1,a,2) Here, “DD (s, w, t)” indicates that a certain address “w” exists and definition of the address “w” in line number “s” reaches line number “t” which references the address “w”.

The variable dependency table 114 for the target program of [0-1] is:

[0-3]

DD(1,a,2)
DD(1,a,4)
DD(2,b,3)
DD(2,b,5)

A control dependency relation analyzer 115 generates a control dependency table 116 based on the syntax tree generated by the syntax analyzing unit 110. Assuming that the syntax tree is given in text notation as [0-2] above, the control dependency relation analyzer 115 first reads the text and takes an expression which is a control statement, such as one in which the attribute “type” of the “stmt” tag is “if” or the like. In this example, L08 to L15 corresponds to such an expression. The line number of the “stmt” tag is also stored. Then, line numbers contained in L08 to L15 are taken and stored. Specifically, a line number in which “stmt” tag is followed by “num” attribute is stored. Then, the line number of the “stmt” tag corresponding to the control statement is combined with each line number taken from L08 to L15 to generate a line number pair. In this example, a pair of expressions 3 and 4 and a pair of expressions 3 and 5 are generated. The relation of each pair is represented with a prefix of “CD” as a control dependency relation. Data on a control dependency relation generated for each pair is saved in the control dependency table 116.

For example, the control dependency table 116 for the target program of [0-1] above is as shown below. Here, “CD(s, t)” means that line number “s” is a control statement and a branch node thereof contains line number “t”.

[0-4]

CD(3,4)
CD(3,5)

A slice extracting unit 118 performs program slicing based on the variable dependency table 114 and control dependency table 116 which are generated as described above as well as a slicing criterion which is separately supplied from a slicing criterion input unit 117 to extract and output a program fragment (a partial program or slice) 119 which has a dependency relation with the slicing criterion. The slicing criterion is represented by, for example, (1) a line number of interest (i.e., a statement of interest) or (2) a pair of a line number of interest and a variable of interest that is contained in the statement having that line number. A program fragment or slice is determined by extracting all statements (line numbers) that have a dependency relation with respect to the slicing criterion based on the variable dependency table 114 and the control dependency table 116.

For example, the slice for expression 5 (L5) as the slicing criterion is determined by finding that the third line depends on L5 from “CD(3, 5)”, the second line in turn depends on the third line from “DD(2, b, 3)”, and the first line depends on the second line from “DD(1, a, 2)”. Accordingly, extraction of all statements (a program fragment) that have a dependency relation with the slicing criterion results in:

[0-5]

L1: a = 10;
L2: b = a * 2;
L3: if( b > 10 ){
L5: d = b;
}

As the way of extracting all dependency relations among expressions, a method for determining a reachable matrix may be employed. For example, when the variable dependency table 114 and the control dependency table 116 for the target program of [0-1] is expressed in a matrix A, the matrix A is represented as:

$$A = \begin{matrix}0 & 1 & 0 & 1 & 0 \\ 0 & 0 & 1 & 0 & 1 \\ 0 & 0 & 0 & 1 & 1 \\ 0 & 0 & 0 & 0 & 0 \\ 0 & 0 & 0 & 0 & 0\end{matrix} \qquad [ 0 \text{-} 6 ]$$

Assuming that unit matrix is “I”, the reachable matrix B of this matrix A is determined as: B=(I+A)⁶.

The program fragment or slice for expression 5 can be obtained by extracting the dependency relations in the fifth row of the reachable matrix B.

Such a conventional program slicing technique as described above is detailed in Document 1 (WEISER, Program Slicing) and Document 2 (Ottenstein, The program dependence graph in a software development environment).

However, such a conventional method sometimes cannot properly extract a program fragment or slice as mentioned in the Related Art.

That is, as the conventional technique performs processing paying attention to variable name, when there are one variable and another variable and those variables point to the same address, the technique considers the two variables not to have a dependency relation with each other. A program fragment also cannot be correctly extracted in a program that contains a union or the like because variables (i.e. member) declared as a union are handled as separate variables. In addition, a program fragment cannot be correctly extracted from a program that contains arrays or pointers.

The embodiments of the present invention enable correct extraction of a program fragment even in such situations.

In the following, the embodiments of the present invention will be described in detail with reference to drawings.

### First Embodiment

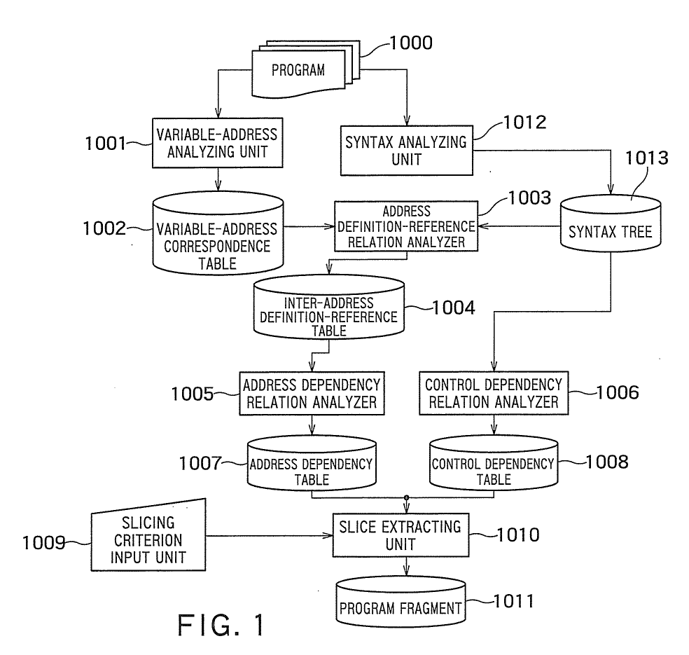

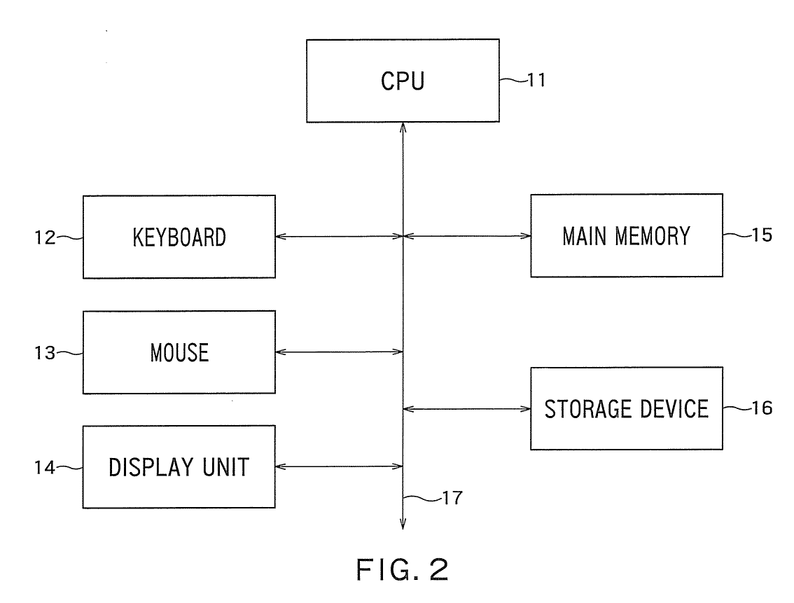

FIG. 2 is a hardware block diagram showing the configuration of a program analysis apparatus according to a first embodiment. The program analysis apparatus includes a storage device 16 for saving data and programs (an analysis program according to the embodiment and a target program to be analyzed), main memory 15 for temporarily storing data, a CPU 11 for reading and loading the analysis program according to this embodiment from the storage device 16 into the main memory 15 to execute the program, a keyboard 12 and a mouse 13 for inputting control instructions and data, and a display 14 on which data is output, the components being interconnected via a bus 17. The analysis program of this embodiment may also be recorded in a computer-readable recording medium, such as a CD-ROM, CD-R, or removable disk, and read and executed by the CPU 11. FIG. 1 is a diagram that represents functions resulting from execution of the analysis program of this embodiment by the CPU 11 as blocks and shows relations of data (or table) input and output associated with those functions between blocks. In other words, FIG. 1 is a functional block diagram of the program analysis apparatus according to the first embodiment.

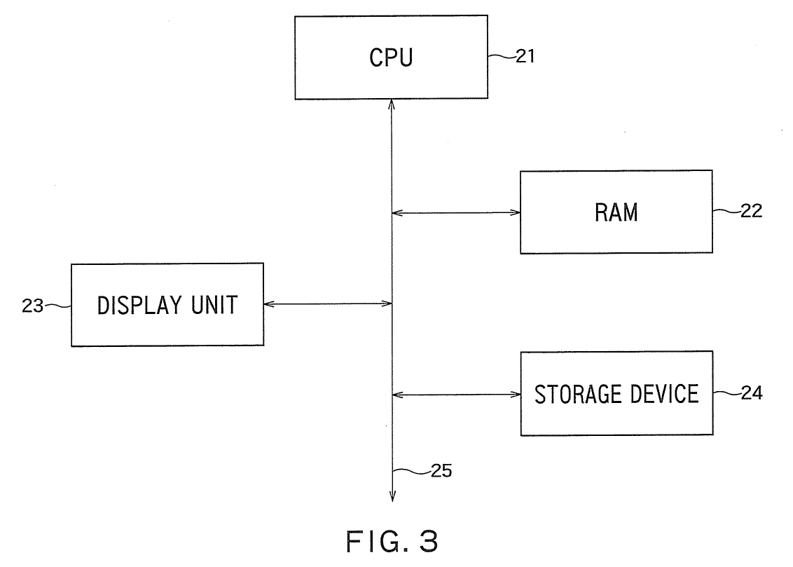

In FIG. 1, a variable-address analyzing unit 1001, a syntax analyzing unit 1012, an address definition-reference relation analyzer (first analyzer) 1003, an address dependency relation analyzer (second analyzer) 1005, a control dependency relation analyzer (third analyzer) 1066, and a slice extracting unit 1010 correspond to the functions that are obtained by having the CPU execute the analysis program of this embodiment. The target program 1000 in the figure is a program as the target of analysis and can be created by inputting character strings from the keyboard 12 and the mouse 13, for example. A variable-address correspondence table 1002, syntax tree 1013, inter-address definition-reference table (definition-reference data) 1004, address dependency table 1007, control dependency table 1008, and program fragment (also called a partial program or a slice. Hereinafter called a program fragment throughout) 1011 represent data or tables generated by the functions described above. A slicing criterion input unit (slicing criterion specifying unit) 1009 corresponds to the keyboard 12 or the mouse 13, for example. The target program 1000 can be executed on a computer system in which the CPU 21, RAM 22, display unit 23, and storage device 24 are interconnected by the bus 25, such as one shown in FIG. 3. In this case, the CPU 21 reads and executes the target program 1000 saved in the storage device 24, and the RAM 22 temporarily stores underway data during execution of the program. The result of program execution is shown on the display unit 23.

In FIG. 1, the program analysis apparatus reads the target program 1000 from the storage device 16 (see FIG. 2) and inputs the program 1000 to the variable-address analyzing unit 1001 and the syntax analyzing unit 1012. The target program 1000 is written in accordance with the grammar of a programming language, such as C language.

The variable-address analyzing unit 1001 uses the target program 1000 input to create a conversion-address correspondence table (or map) 1002 that associates variable names and absolute addresses to each other. An absolute address is an address in memory at which a variable is temporarily stored while the target program 1000 is actually executed.

This example assumes input of a target program 1000 in which one variable and another variable point the same address using an absolute address, as shown below. A variable “a” and a variable “b” indicate the same address.

[1-1]

L1: #pragma ADDRESS a 0x0001
L2: #pragma ADDRESS b 0x0001
L3: #pragma ADDRESS c 0x0002
L4: #pragma ADDRESS d 0x0003
L5: a = 10;
L6: if( b > 10 ){
L7: c = a;
L8: d = b;
}

The variable-address analyzing unit 1001 first reads in the target program 1000 on a line-by-line basis and takes lines which contain “# pragma” at the start thereof. A set of lines that contain “# pragma” at the start thereof corresponds to address definition data, for example.

Then, the variable-address analyzing unit 1001 divides each of the lines into tokens with space characters and detects lines whose second token is “ADDRESS”. Then, it adds detected lines to the variable-address correspondence table 1002 setting their third token as variable name and the fourth token as absolute address. The variable-address correspondence table 1002 generated from the target program of [1-1] is shown below:

[1-2]

a 0x0001
b 0x0001
c 0x0002
d 0x0003

The syntax analyzing unit 1012 reads the target program 1000 and performs syntax analysis on lines other than ones in which absolute addresses are specified so as to create the syntax tree 1013 that represents the syntax of the target program 1000 in a tree structure. The created syntax tree 1013 is temporarily saved in the main memory 15. The syntax analysis is performed by analyzing character strings according to syntax rules and determining whether they have a structure acceptable in the target programming language (e.g., C language).

For example, the syntax tree of a program:

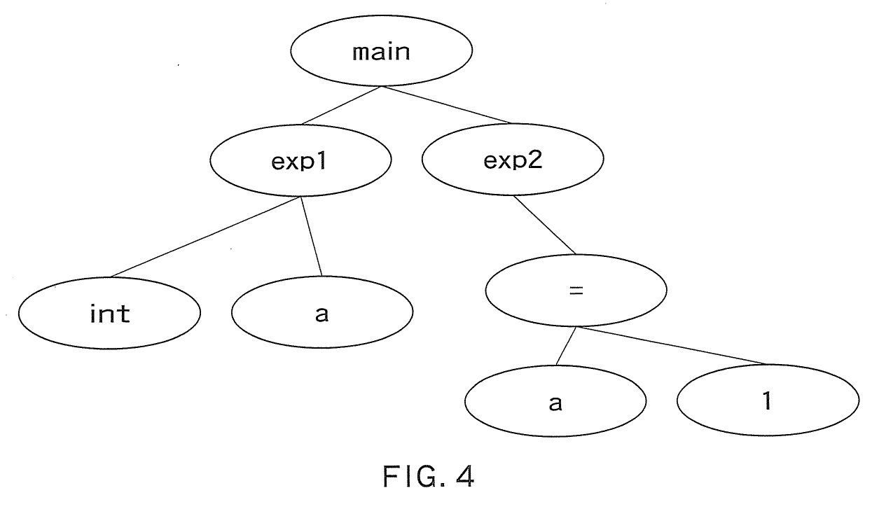

01:main( ){
02: int a;
03: a = 1;
04:}
is as shown in FIG. 4.

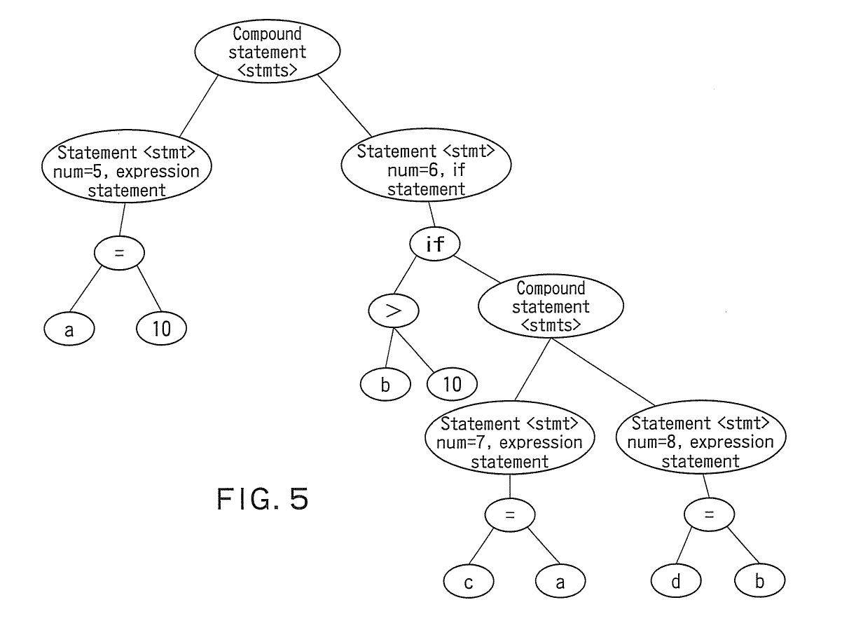

More specifically, syntax analysis first reads in the target program 1000, applies lexical analysis to decompose the program into tokens, such as “=” and numerical values, and then determines whether the sequence of the tokens conforms to the grammar of the program. Finally, a labeled directed graph called a syntax tree is output. A syntax tree can also be represented in XML format (i.e., text notation). The text notation of the syntax tree created from the target program of [1-1] is shown below, and the structure of this syntax tree is shown in FIG. 5.

[1-3]

```
L01:<stmts>
L02: <stmt num=” 5” type=” exp” >
L03: <node op=” =” ><l>a</l><r>10</r></node>
L04: </stmt>
L05: <stmt num=” 6” type=” if” >
L06: <node>
L07: <l><node op=” >” ><l>b</l><r>10</r></node></l>
L08: <r><stmts>
L09: <stmt num=” 7” type=” exp” ><node op=” =” >
              <l>c</l><r>a</r></node></stmt>
L10: <stmt num=” 8” type=” exp” ><node op=” =” >
              <l>d</l><r>b</r></node></stmt>
L11: </stmts></r>
L12: </stmt>
L13:</stmts>
```

In the representation above, multiple statements are represented by a <stmts> tag and each statement is by a <stmt> tag. A line number of the statement is represented by “num” attribute. When the type of a statement is an iteration statement such as “if”, “for”, or “while” statement, selection statement, labeled statement, expression statement, compound statement, or branch statement, the type is described in “type” attribute. When a statement is an expression statement, “exp” attribute is added. The inside of an expression is represented as a binary tree, wherein a node is represented by <node> tag and a token to which the node belongs is represented by “op” attribute. The left branch from a node is represented by <I> tag and the right branch from the node by <r> tag.

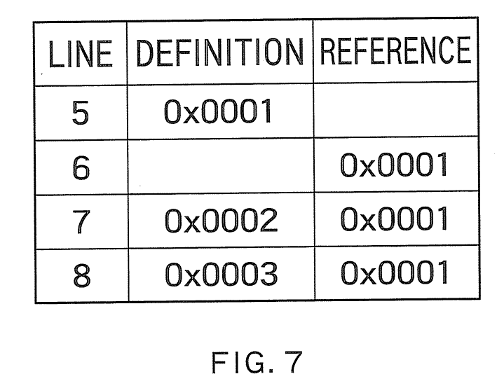

The address definition-reference relation analyzer 1003 reads in the syntax tree 1013 and the variable-address correspondence table 1002, and for each of the statements contained in the syntax tree 1013, generates an inter-address definition-reference table (definition-reference data) 1004 that associates its line number, the address of the definition variable, and the address of the reference variable to each other. The inter-address definition-reference table (definition-reference data) 1004 generated from the syntax tree of [1-3] and the variable-address correspondence table 1002 of [1-2] is shown in FIG. 7. The first column represents line number and corresponds to “num” attribute of <stmt> tag in [1-3]. The second column represents the address of the definition variable, and the third column represents the address of the reference variable.

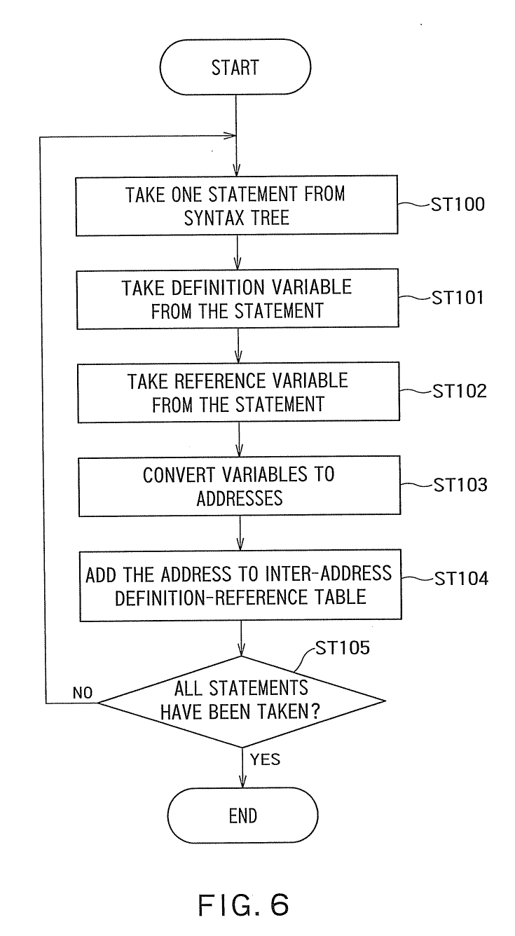

FIG. 6 is a flowchart illustrating the operational flow of the address definition-reference relation analyzer 1003 according to the first embodiment.

First, one statement is taken from a syntax tree (ST100). One statement can be taken by giving an expression number (here, exp1, exp2) to the root as the start of a statement in the syntax tree and extracting information below the root that matches the expression number as shown in FIG. 4.

Then, a definition variable is taken from the statement (ST101). A definition variable refers to a variable into which a value after execution of an expression is assigned (typically a variable on the left side of an equal sign) when the statement contains an equal sign (i.e., an assignment operation symbol ((the “op” attribute of <node> tag is “=”)). In expression 7 (L7) in [1-1], for example, variable “c” is the definition variable.

Then, the reference variable is taken from the statement (ST102). A reference variable is a variable whose value is called when the statement is executed. For example, in expression 7 (L7) in [1-1], variable “a” is the reference variable, and in expression 8 (L8), variable “b” is the reference variable. When the type of <stmt> tag is “if”, the <I> tag in <node> tag below the <stmt> tag is read in, and a variable name below the <I> tag is set as the reference variable. For example, in expression 6 (L6), variable “b” is the reference variable.

Next, the definition variable and the reference variable are each converted to an address (ST103).

Then, the correspondence between the line number of the statement, the address of the definition variable, and the address of the reference variable is registered in the inter-address definition-reference table (definition-reference data) 1004 (ST104).

Next, it is determined whether all statements have been taken (ST105). If not all statements have been taken (NO), the flow returns to ST100, and if all statements have been taken (YES), processing is terminated.

The address dependency relation analyzer 1005 uses the inter-address definition-reference table (definition-reference data) 1004 to create the address dependency table (address dependency data) 1007 that for each definition variable, associates the address of the definition variable, the line number of the statement that contains the definition variable, and the line number of a statement that contains the reference variable having the same address as the definition variable to each other. The address dependency table 1007 created from the inter-address definition-reference table (definition-reference data) 1004 of FIG. 7 is as shown below:

[1-4]
DD(5,0x0001,6)
DD(5,0x0001,8)
DD(5,0x0001,7)

Here, “DD(s, w, t)” means that a certain address “w” exists and the definition of the address “w” in line number “s” reaches line number “t” which references the address “w”.

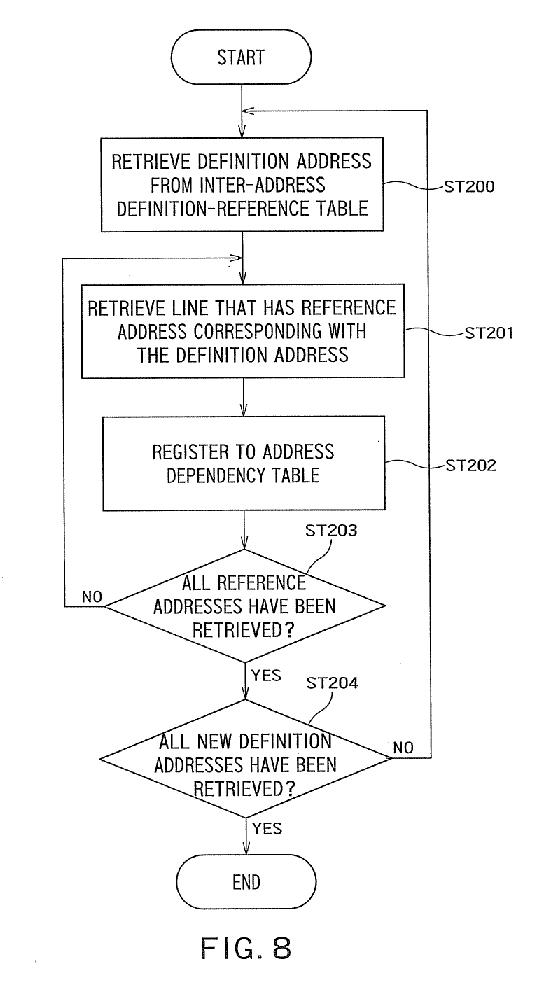

FIG. 8 is a flowchart illustrating the operational flow of the address dependency relation analyzer 1005 according to the first embodiment.

First, a definition address (the address of a definition variable) and a line number which contains the definition address are retrieved from the inter-address definition-reference table (definition-reference data) 1004 (ST200).

Then, a reference address (the address of a reference variable) that corresponds with the definition address is detected in the inter-address definition-reference table (definition-reference data) 1004, and the line number of the reference address detected is retrieved (ST201).

Then, the line number of the definition address, the definition address, and the line number of the reference address are registered in the address dependency table 1007 as a set (ST202).

Then, it is determined whether all reference addresses that correspond with the definition address retrieved at ST200 have been detected or not (ST203).

If there is any reference address not detected yet (NO at ST203), the flow returns to ST200, and if all reference addresses have been detected (YES), it is determined whether there is any definition address not retrieved yet (ST204). If there is a definition address not retrieved yet (NO), the flow returns to ST200, and if all definition addresses have been retrieved (YES), processing is terminated.

The control dependency analyzing unit 1006 detects a control statement and a controlled-object statement which is executed depending on the result of executing the control statement based on the syntax tree 1013, and creates a control dependency table (control dependency data) 1008 that maps the line number of the control statement to the line number of the controlled-object statement. The control dependency table 1008 created from the syntax tree of [1-3] above is:

CD(6,7)
CD(6,8)

Here, “CD(s, t)” means that line number “s” is a control statement and a branch node thereof contains line number “t”.

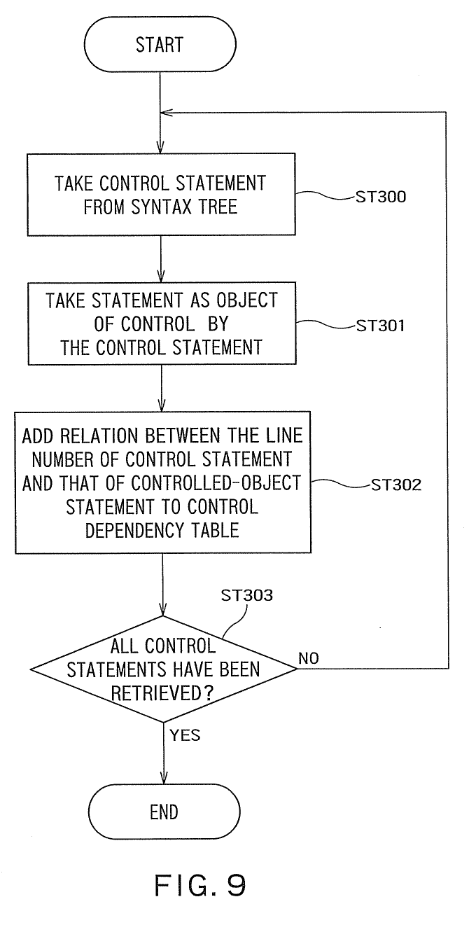

FIG. 9 is a flowchart illustrating the operational flow of the control dependency relation analyzer 1006 based on the first embodiment.

First, a control statement is taken from the syntax tree 1013 (ST300). A control statement refers to, in C language, for example, a conditional branch statement such as an “if” and “switch” statement, or an iteration statement such as a “for”, “while”, and “do-while” statement. In a syntax tree, when a keyword indicating a control statement is present within an expression taken, the expression can be determined to be a control statement. In the target program of [1-1], “if(b>10)” corresponds to a control statement.

Then, the line number of a controlled-object statement which is executed depending on the control statement is taken (ST301).

Then, a pair of the line number of the control statement and the line number of the controlled-object statement is added to the control dependency table 1008 (ST302). For the target program of [1-1], for instance, a pair of L6 and L7, and a pair of L6 and L8 are obtained.

Then, it is determined whether all control statements have been retrieved (ST303). If there is any control statement not retrieved yet (NO), the flow returns to ST300, and if all control statements have been retrieved (YES), processing is terminated.

The slicing criterion input unit 1009 inputs a slicing criterion. A slicing criterion is a line number of interest (i.e., a statement of interest), for example. In addition to a line number of interest, a slicing criterion may also include designation of a variable of interest that is contained in the statement in that line number. When the slicing criterion input unit 1009 is a keyboard, for example, a line number may be input through key entry, or when it functions as a file input unit, a line number may be input as a file. A slicing criterion can also be input with the number of mouse clicks. The slicing criterion input unit 1009 outputs such an externally input slicing criterion to the slice extracting unit 1010. The program analysis apparatus according to this embodiment may include a slicing criterion designating unit for designating an arbitrary line number in a target program as the slicing criterion.

The slice extracting unit 1010 uses the address dependency table 1007 and the control dependency table 1008 to extract all statements (or lines) that have a dependency relation with the slicing criterion input, thereby obtaining the program fragment (i.e. slice) 1011. More specifically, starting from the statement in the line number indicated in the slicing criterion, it extracts a set of all statements that are reached from the slicing criterion based on the address dependency table 1007 and the control dependency table 1008 as the program fragment (i.e. slice) 1011. A slice can also be extracted by calculating a reachable matrix for the address dependency table 1007 and the control dependency table 1008 and utilizing the reachable matrix.

Extracting a program fragment for expression 8 (line number L8) as the slicing criterion based on the address dependency table 1007 and the control dependency table 1008 in this example results in:

L5: a = 10;
L6: if( b > 10 ){
L8: d = b;
}

It shows that the sixth line depends on L8 from “CD(6, 8)” and the fifth line in turn depends on the sixth line from “DD(5, 0x0001,6)”. In this way, dependency relations with expression 8 (L8) can be correctly extracted. While this example shows backward slicing as the way of slicing, forward slicing may also be performed or both of these types of slicing may be performed to extract a sum set for the two types as the program fragment.

When the conventional technique described above is employed on the target program of [1-1], a set of statements that have dependency relations cannot be correctly extracted as in this embodiment, which will be demonstrated below.

The inter-variable definition-reference table 112 that is generated using the conventional technique illustrated in FIG. 20 is as shown in FIG. 22.

The variable dependency table 114 and control dependency table 116 are as shown below:

DD(5,a,7)
CD(6,7)
CD(6,8)

A program fragment for expression 8 (L8) extracted from these tables is:

L6: if( b > 10 ){
L8: d = b;
}

Thus, it is understood that the conventional technique cannot correctly extract dependency relations for the target program of [1-1].

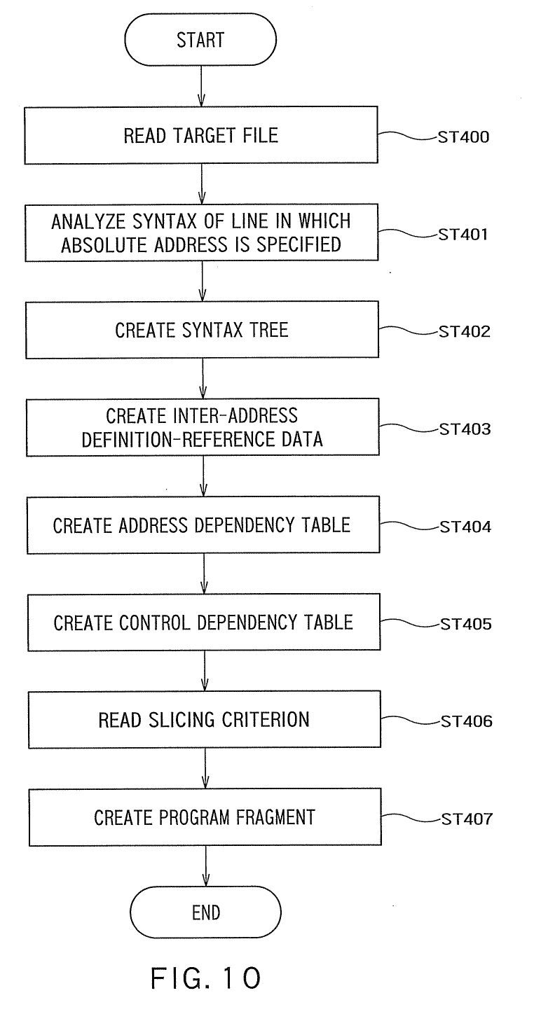

FIG. 10 is a flowchart illustrating an example of the program analysis method according to the first embodiment.

First, a target program 1000 (a file) is read in (ST400).

Then, the variable-address correspondence table 1002 is generated by analyzing the syntax of a line in which an absolute address is specified, such as a pragma statement, in the target program 1000 (ST401).

Then, the syntax tree 1013 is created by performing syntax analysis on portions other than where an absolute address is specified in the target program 1000 (ST402).

Then, the inter-address definition-reference table (definition-reference data) 1004 is created from the syntax tree 1013 and the variable-address correspondence table 1002 (ST403).

Next, the address dependency table 1007 is created from the inter-address definition-reference table (definition-reference data) 1004 (ST404).

Then, the control dependency table 1008 is created from the syntax tree 1013 (ST405).

Next, the slicing criterion is read in (ST406), and a program fragment is created by performing slicing (ST407).

The order of the steps shown above is illustrative only and the present invention is not limited to this order. For example, ST404 and ST405 may be interchanged, in which case the advantageous effect of the invention remains intact.

As described above, according to this embodiment, statements that have dependency relations with each other can be correctly extracted because slicing is performed based on address dependency. In addition, as processing can be performed paying attention to dependency relations between addresses only, processing can be simplified and thus faster. In addition, this embodiment can handle a combination of multiple syntaxes as well.

### Second Embodiment

This embodiment shows an example where the program analysis apparatus of the first embodiment is used to slice a target program that contains a union. An example of the target program 1000 having a union is shown below, where “data1” is the union and “data1.a” and “data1.b[. . . ]” represent members of the union.

[2-1]

L1:#pragma ADDRESS data1 0x0001
L2:#pragma ADDRESS b 0x0002
L3:#pragma ADDRESS c 0x0003
L4:#pragma ADDRESS d 0x0004
L5: union data {
L6: short a, char b[2] } data1;
L7: data1.a = 256;
L8: b = data1.b[1];
L9: if( b > 0 ){
L10: c = data1.b[b];
L11: d = b;
L12: }

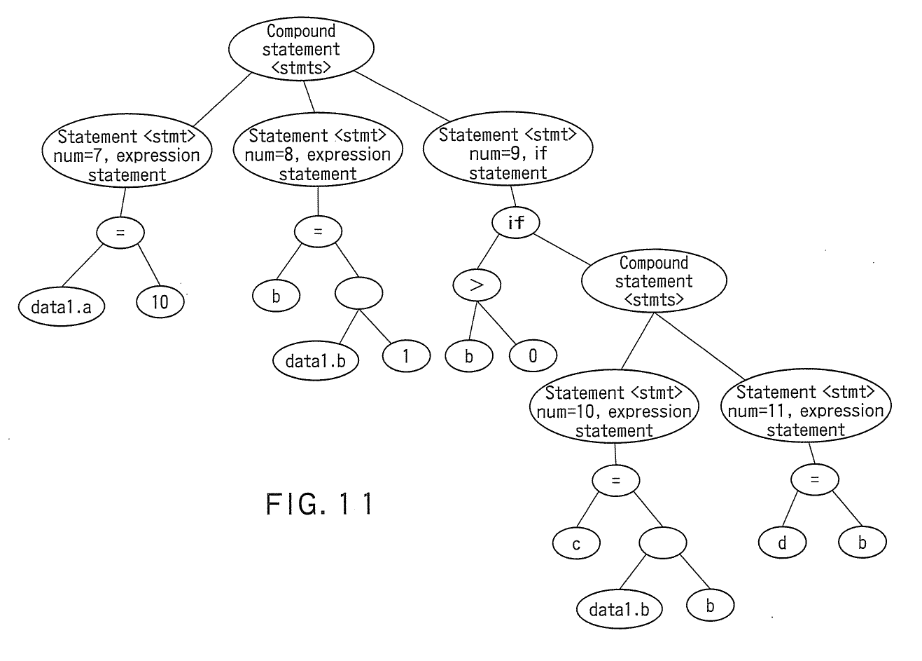

First, the syntax tree 1013 is created from the target program of [2-1] by the syntax analyzing unit 1012. The syntax tree 1013 created is shown in FIG. 11 and the text notation of the syntax tree is shown below:

[2-2]

```
L01:<stmts>
L02: <stmt num=” 7” type=” exp” >
L03: <node op=” =” ><l>data1.a</l><r>10</r></node>
L04: </stmt>
L05: <stmt num=” 8” type=” exp” >
L06: <node op=” =” ><l>b</l><r><node><l>data1.b</l>
        <r>1</r></node></r></node>
L07: </stmt>
L08: <stmt num=” 9” type=” if” >
L09: <node>
L10: <l><node op=” >” ><l>b</l><r>10</r></node></l>
L11: <r><stmts>
L12: <stmt num=” 10” type=” exp” >
L13: <node op=” =” ><l>c</l><r><node><l>data1.b</l>
                <r>b</r></node></r></node></stmt>
L14: <stmt num=” 11” type=” exp” ><node op=” =” ><l>d
              </l><r>b</r></node></stmt>
L15: </stmts></r>
L16: </stmt>
L17:</stmts>
```

Next, the variable-address analyzing unit 1001 creates the variable-address correspondence table 1002 from the target program of [2-1]. The variable-address correspondence table 1002 created is shown below:

[2-3]

| | |
|---|---|
| data1 | 0x0001 |
| b | 0x0002 |
| c | 0x0003 |
| d | 0x0004 |

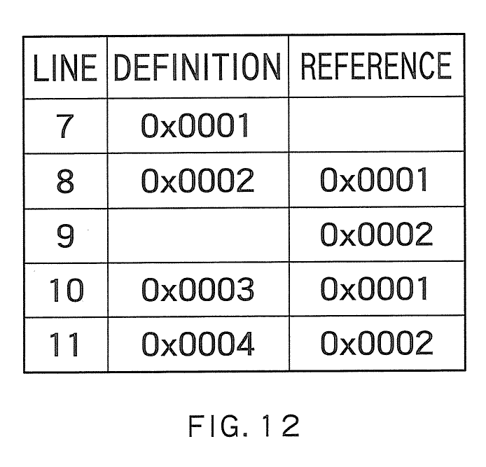

Then, the address definition-reference relation analyzer 1003 creates the inter-address definition-reference table (definition-reference data) 1004 from the variable-address correspondence table 1002 of [2-3] and the syntax tree 1100 of [2-2]. The inter-address definition-reference table (definition-reference data) 1004 created is shown in FIG. 12. Members of the union, such as “data1.a” and “data1.b[1]”, (variables containing “data1” in their variable name), are all converted to the starting address of “data1”, 0x0001. Variables not relating to the union may be processed as in the first embodiment.

Next, the address dependency relation analyzer 1005 creates the address dependency table 1007 from the inter-address definition-reference table (definition-reference data) 1004, and the control dependency relation analyzer 1006 creates the control dependency table 1008 from the syntax tree 1013. The address dependency table 1007 and the control dependency table 1008 created are shown below as [2-4] and [2-5], respectively:

[2-4]

DD(7,0x0001,8)
DD(7,0x0001,10)
DD(8,0x0002,9)
DD(8,0x0002,11)

[2-5]
CD(9,10)
CD(9,11)

Next, extracting the program fragment 1011 for expression 11 (L11) as the slicing criterion, for example, based on the address dependency table 1007 and the control dependency table 1008 by the slice extracting unit 1010 results in:

L7: data1.a = 256;
L8: b = data1.b[1];
L9: if( b > 0 ){
L11: d = b;
}

Thus, statements having dependency relations (a program fragment) can be correctly extracted even from a target program that contains a union.

### Third Embodiment

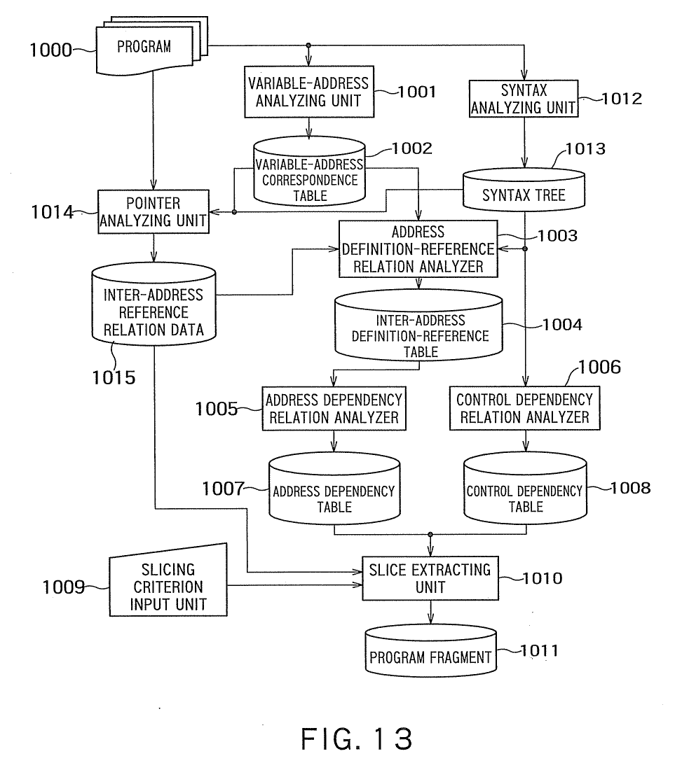

FIG. 13 is a functional block diagram of a program analysis apparatus according to a third embodiment. The program analysis apparatus of FIG. 13 is realized by having a CPU in a system such as the one shown in FIG. 2 execute the analysis program according to this embodiment as in the first embodiment. The operation of the program analysis apparatus of FIG. 13 will be described below by illustrating a target program that contains a pointer.

To the program analysis apparatus of FIG. 13, a target program 1000 to be analyzed is read from the storage device 16. In this embodiment, a target program with a pointer is input, an example of which is shown below. For the sake of representation simplicity, definition statements of variables are omitted. Variable “b” is a pointer variable.

[3-1]

L00:#pragma ADDRESS a 0x0001
L01:#pragma ADDRESS b 0x0002
L02:#pragma ADDRESS c 0x0003
L03:#pragma ADDRESS d 0x0004
L04:#pragma ADDRESS e 0x0005
L05:a = 10;
L06:b = &a;
L07:c =*b * 2;
L08:if( c > 10 ){
L09: d = a;
L10: e = *b;
L11:}

The variable-address analyzing unit 1001 creates the variable-address correspondence table 1002 from the target program 1000 input. More specifically, the variable-address analyzing unit 1001 takes a pair of a variable name and an address contained in a line in which a statement starts with “# pragma” as in the first embodiment, and stores the pair in the variable-address correspondence table 1002. The variable-address correspondence table 1002 created is saved in the storage device 16 or temporarily stored in the main memory 15.

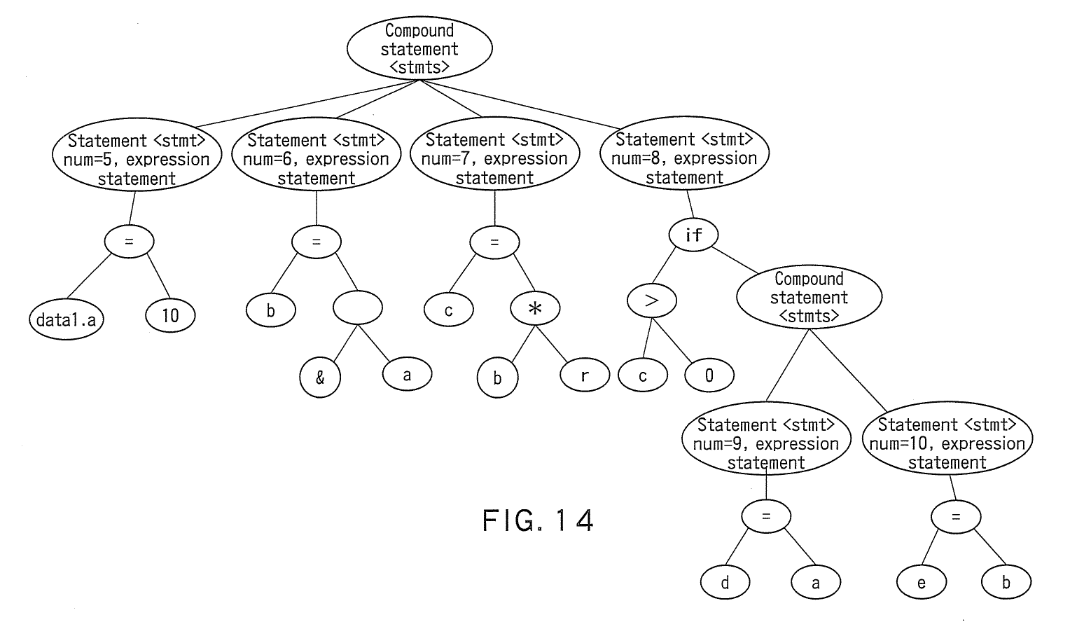

The syntax analyzing unit 1012 reads the input target program 1000 and performs syntax analysis to create the syntax tree 1013. The structure of the syntax tree 1013 created from the target program of [3-1] is shown in FIG. 14 and text notation of this syntax tree is shown below:

[3-2]

```
L01:<stmts>
L02: <stmt num=” 5” type=” exp” >
L03: <node op=” =” ><l>a</l><r>10</r></node>
L04: </stmt>
L05: <stmt num=” 6” type=” exp” >
L06: <node op=” =” ><l>b</l><r>
        <node><l>&</l><r>a</r></node></r></node>
L07: </stmt>
L08: <stmt num=” 7” type=” exp” >
L09: <node op=” =” ><l>c</l><r><node op=” *” >
<l>b</l><r>2</r></node></r></node>
L10: </stmt>
L11: <stmt num=” 8” type=” if” >
L12: <node>
L13: <l><node op=” >” ><l>c</l><r>10</r></node></l>
L14: <r><stmts>
L15: <stmt num=” 9” type=” exp” >
                <node op=” =” ><l>d</l><r>a</r></node></stmt>
L16: <stmt num=” 10” type=” exp” >
                <node op=” =” ><l>e</l><r>b</r></node></stmt>
L17: </stmts></r>
L18: </stmt>
L19:</stmts>
```

A pointer analyzing unit 1014 reads the target program 1000, variable-address correspondence table 1002, and syntax tree 1013 and performs pointer analysis on them to generate inter-address reference relation data 1015. Known techniques of pointer analysis include Das's method (Manuvir Das, Unification-based Pointer Analysis with Directional Assignment), for example.

The operation of the pointer analyzing unit 1014 is shown below.

First, a statement (a assignment statement) in which address operation using an address is conducted is taken from the syntax tree 1013. In [3-1], a statement in which the address operation is performed is “b &a;” of expression 6 (L6).

Then, a called variable in the address operation, that is, the variable “a” on the right side of the equal sign, is taken from the statement and an address corresponding to this called variable is retrieved from the variable-address correspondence table 1002. “a” is an example of a variable whose address is taken with a pointer operator “&”. Also, an assignment target variable (pointer) to which the address (i.e. result of the address operation) is assigned, that is, the variable (pointer) “b” on the left side of the equal sign, is taken and an address corresponding to the variable (pointer) is retrieved from the variable-address correspondence table 1002. Then, the dependency relation between those addresses is represented as, for example, “(the address corresponding to the assignment target variable)→(the address corresponding to the called variable)” and saved as inter-address reference relation data 1015.

For the target program of [3-1],

0x0002→0x0001

is obtained for expression 6 (L06) as the inter-address reference relation data 1015.

Here, a right-pointing arrow (“→”) indicates a rule to replace address 0x0002 with address 0x0001 when address 0x0002 is specified.

The address definition-reference relation analyzer 1003 reads in the syntax tree 1013, variable-address correspondence table 1002, and inter-address reference relation data 1015, and creates the inter-address definition-reference table (definition-reference data) 1004. The inter-address definition-reference table (definition-reference data) 1004 created is temporarily stored in the main memory 15. In the following, a procedure for creating the address definition-reference table 1004 is described with reference to FIG. 6.

First, one statement is taken from the syntax tree 1013 (ST100).

Then, a definition variable is taken from the statement (ST101). For instance, in expression 7 (L07) in [3-1], the variable “c” is the definition variable. However, the variable “b” in expression 6 (L06) is not a definition variable because an address is assigned thereto (i.e., not a value is assigned).

Next, a reference variable is taken from the statement (ST102). For example, in expression 7 (L07) of [3-1], the variable “b” is the reference variable, and in expression 8 (L08), expression “c” is the reference variable. However, the variable “a” in expression 6 (L06) is not a reference variable because an address is called therefrom (i.e., not a value is called).

Next, addresses that correspond to the definition and reference variables are read from the variable-address correspondence table 1002 (ST103), and added to the inter-address definition-reference table (definition-reference data) 1004 (ST104). At this point, if “an address that corresponds to the assignment target variable” exists based on the inter-address reference relation data 1015, that address is converted (replaced) to “the address corresponding to the called variable”.

Then, it is determined whether all statements in the syntax tree have been processed (ST105), and if all the statements have been processed (YES), processing is terminated.

The inter-address definition-reference table (definition-reference data) 1004 created through the processing is:

[3-3]

| row | definition | reference |
|---|---|---|
| L05 | 0x0001 | |
| L07 | 0x0003 | 0x0001 |
| L08 | | 0x0003 |
| L09 | 0x0004 | 0x0001 |
| L10 | 0x0005 | 0x0001 |

The address dependency relation analyzer 1005 then reads in the inter-address definition-reference table (definition-reference data) 1004 and creates the address dependency table 1007. This processing may be performed according to the flow shown in FIG. 8 as in the first embodiment. The address dependency table 1007 created is temporarily stored in the main memory 15 or alternatively may be saved in the storage device 16 as a file.

The address dependency table 1007 created from the inter-address definition-reference table (definition-reference data) 1004 of [3-3] is shown below:

[3-4]

| s | w | T |
|---|---|---|
| L05 | 0x0001 | L08 |
| L05 | 0x0001 | L09 |
| L05 | 0x0001 | L10 |
| L07 | 0x0003 | L08 |

Next, the control dependency relation analyzer 1006 creates the control dependency table 1008 based on the syntax tree 1013. This processing is performed in accordance with the flow shown in FIG. 9 as in the first embodiment. The control dependency table 1008 created is temporarily stored in the main memory 15 or alternatively may be saved in the storage device 16 as a file.

Since control dependency relations exist between L08 and L09 and between L08 and L10 in the target program of [3-1], such a control dependency table 1008 as shown below is obtained:

CD(8,9)
CD(8,10)

As mentioned in the first embodiment, “CD(s, t)” means line number “s” is a control statement and a branch node thereof contains line number “t”.

Then, the slicing criterion input unit 1009 reads in a slicing criterion. The slicing criterion is a line number, for example.

The slice extracting unit 1010 then creates the program fragment (or a slice) 1011 by taking all statements (or lines) that have dependency relation with the slicing criterion based on the address dependency table 1007 and the control dependency table 1008, and inter-address reference relation data 1015.

For example, for the target program of [3-1], the program fragment 1011 with respect to line number 10 is:

L06: b = &a;
L07: c = *b * 2;
L08: if( c > 10 ){
L10: e = *b;
}

Since the address of reference variable “b” in the slicing criterion is 0x0001 and the inter-address reference relation data 1015 is 0x0002→0x0001, an expression corresponding to “0x0002→0x0001” (L06) has been extracted as a line that has a dependency relation with the slicing criterion.

The program fragment 1011 extracted may be shown on the display unit 14 or saved in the storage device 16.

Now, [3-5] will be shown as another example of the target program containing pointers. Definition of variables is omitted for simplicity of representation. Variables “a” and “b” are pointer variables which stores an address, respectively. Exemplary processing in this embodiment is shown based on this target program.

[3-5]

L1:#pragma ADDRESS a 0x0001
L2:#pragma ADDRESS b 0x0003
L3:#pragma ADDRESS c 0x0004
L4:#pragma ADDRESS d 0x0005
L5:#pragma ADDRESS e 0x0006
L6: *a = 10;
L7: *(a+1) = 1;
L8: b = a;
L9: c = *(b+1) * 2;
L10: if( c > 10 ){
L11: d = *a;
L12: e = *b;
}

Pointer analysis by the pointer analyzing unit 1014 results in the following [3-6] for expression 8 (L8), as the inter-address reference relation data 1015. Incidentally, in the expression 8 (L8), “a” in itself is assigned to “b” as a result of the address operation based on “a”. If “a” in the expression 8 (L8) is replaced with “++a”, a value (address) obtained by adding one to “a” corresponds to the result of the address operation based on “a”. “a” is a called variable (first pointer) and “b” is an assignment target variable (second pointer).

[3-6]

0x0003 -> 0x0001

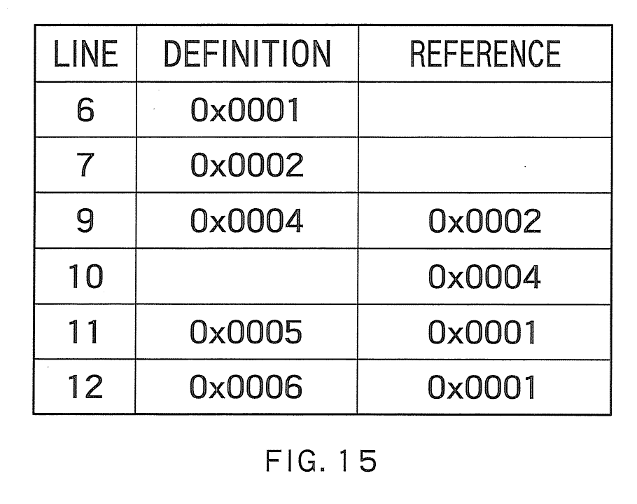

Also, processing by the address definition-reference relation analyzer 1003 provides the inter-address definition-reference table (definition-reference data) 1004 shown in FIG. 15.

Also, processing by the address dependency relation analyzer 1005 and the control dependency relation analyzer 1006 provides the following as the address dependency table 1007 and the control dependency table 1008.

[3-7]

DD(6,0x0001,11)
DD(6,0x0001,12)
DD(7,0x0002,9)
DD(9,0x0004,10)

[3-8]

CD(10,11)
CD(10,12)

A program fragment for expression 12 (L12) as the slicing criterion is extracted based on the address dependency table 1007 of [3-7], the control dependency table 1008 of [3-8], and the inter-address reference relation data 1015 of [3-6] as follows.

L6: *a = 10;
L7: *(a+1) = 1;
L9: c = *(b+1) * 2;
L10: if( c > 10 ){
L12: e = *b;
}

Thus, according to this embodiment, statements having dependency relations can be correctly extracted even in a target program containing pointers.

### Fourth Embodiment

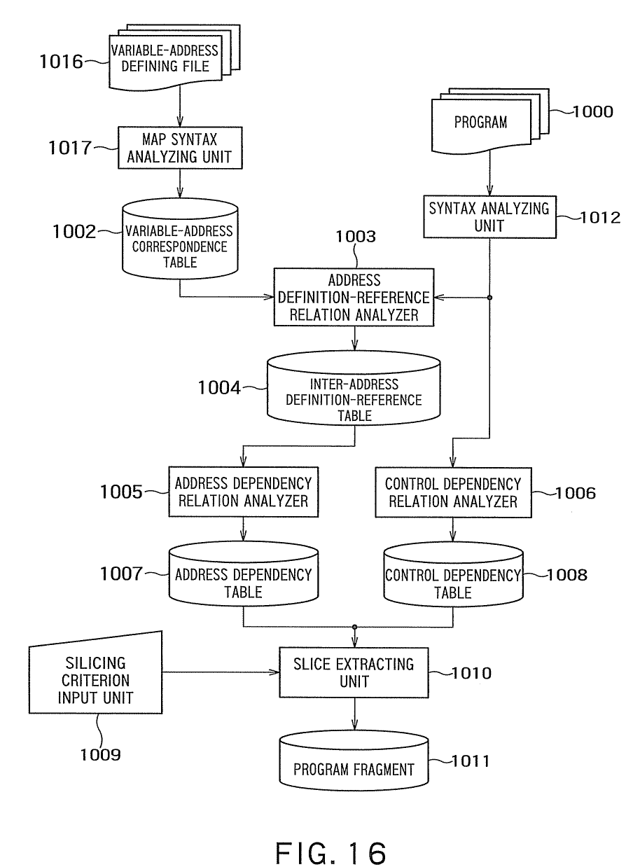

FIG. 16 is a functional block diagram of a program analysis apparatus according to a fourth embodiment. In the following, only differences from the program analysis apparatus of the first embodiment shown in FIG. 1 are described and overlapping description is omitted as this embodiment is otherwise similar to the first embodiment.

In the first embodiment, data that defines correspondence between variables and addresses (address definition data) is described in a target program, whereas this embodiment gives such address definition data as a variable-address defining file 1016 separately from the target program and does not include the address definition data in the target program. An example of the variable-address defining file 1016 is shown below:

[4-1]

```
a 0x0001
  b 0x0001
  c 0x0002
  d 0x0003
```

Map syntax analyzing unit 1017 analyzes correspondence between variable names and addresses from the variable-address defining file 1016 and creates the variable-address correspondence table 1002.

For example, when the variable-address defining file 1016 of [4-1] is given as a text file, the map syntax analyzing unit 1017 reads the file line by line, divides one line into two character strings with a space, and sets the character string on the left side as a variable and that on the right side as an address value to obtain the variable-address correspondence table 1002.

### Fifth Embodiment

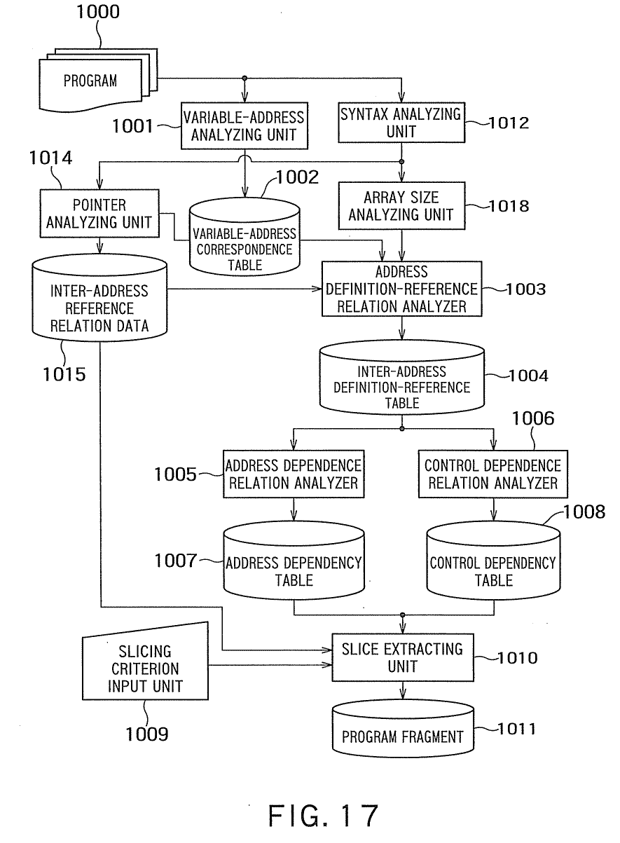

FIG. 17 is a functional block diagram of a program analysis apparatus according to a fifth embodiment. The program analysis apparatus of this embodiment is characterized in that it analyzes a target program that specifies an index of an array with a variable (i.e. a target program that includes an array with a variable index). By way of example, such a target program written in C language as shown below is input to the program analysis apparatus. In expression 6 (L6), an array variable “a” is defined. In expression 11 (L11), the index of the array variable “a” is specified with a variable “c” and conditional branch takes place depending on the value of the array variable “a”.

[6-1]

L1:#pragma ADDRESS a 0x0000
L2:#pragma ADDRESS b 0x0003
L3:#pragma ADDRESS c 0x0004
L4:#pragma ADDRESS d 0x0005
L5:#pragma ADDRESS e 0x0006
L6:int a[2],*b;
L7: a[0] = 10;
L8: a[1] = 1;
L9: b = &a[0];
L10: c = 0;
L11: if( a[c] > 10 ){
L12: d = a[0];
L13: e = b[0];
}

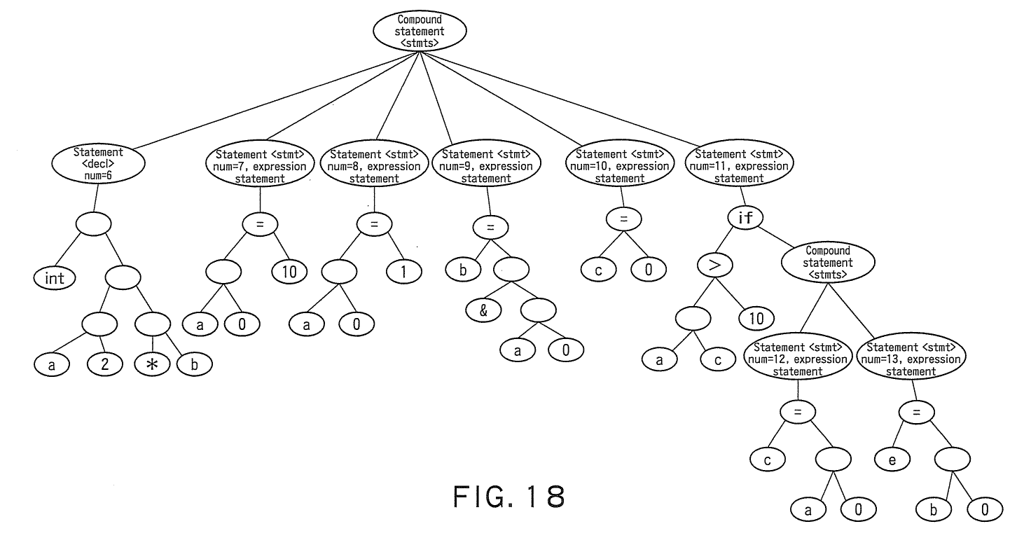

The syntax analyzing unit 1012 reads in the target program 1000 and performs syntax analysis thereon to create the syntax tree 1013. Text notation of the syntax tree 1013 created is shown below. The structure of the syntax tree 1013 is shown in FIG. 18. In the text notation below, a <dec> tag represents declaration.

[6-2]

L01:<stmts>
L02: <decl num=” 6” >
L03: <node>
L04: <l>int</l>
L05: <r>
L06: <node><l>a</l><r>2</r></node><node><l>*</l><r>b</r></node>
L07: </r>
L08: </node>
L09: </decl>
L10: <stmt num=” 7” type:=” exp” >
L11: <node op=” =” ><l><node><l>a</l><r>0</r></node></l><r>10</r></node>
L12: </stmt>
L13: <stmt num=” 8” type=” exp” >
L14: <node op=” =” ><l><node><l>a</l><r>1</r></node></l><r>1</r></node>
L15: </stmt>
L16: <stmt num=” 9” type=” exp” >
L17: <node op=” =” >
L18: <l>b</l>
L19: <r><node><l>&</l><r><node><l>a</l><r>0</r></node></r></node></r>
L20: </node>
L21: </stmt>
L22: <stmt num=” 10” type=” exp” ><node op=” =” ><l>c</l><r>0</r></node></stmt>
L23: <stmt num=” 11” type=” if” >
L24: <node>
L25: <l><node op=” >” ><l><node><l>a</l><r>c</r></node></l><r>10</r></node></l>
L26: <r><stmts>
L27: <stmt num=” 12” type=” exp” >
L28: <node op=” =” ><l>c</l><r><node><l>a</l><r>0</r></node></node></stmt>
L29: <stmt num=” 13” type=” exp” >
L30: <node op=” =” ><l>d</l><r><node><l>b</l><r>0</r></node></r></node></stmt>
L31: </stmts></r>
L32: </stmt>
L33:</stmts>

An array size analyzing unit 1018 obtains the array size of the declared array variable from the created syntax tree. When the syntax tree is [6-2], for example, the syntax tree is read starting from L01 and lines containing a <decl> tag are taken. Here, L0 to L09 are such lines. Next, in the “dec” tag tree, a declared variable exists in the right branch of the node below the “dec” tag and this variable is thus read in. When this variable is a node (a “node” tag) and when, further below the node, the right node is a numerical value and the left node is a variable, an array declaration is shown. Therefore, by reading in the numerical value “2” in the right node and the variable “a” in the left node, it is found that the variable “a” is an array variable having indices from 0 to 2.

Next, the variable-address correspondence table 1002 is created by the variable-address analyzing unit 1001. Shown below is the variable-address correspondence table 1001 created for the target program of [6-1]:

[6-3]

a 0x0000
b 0x0003
c 0x0004
d 0x0005
e 0x0006

Next, the pointer analyzing unit 1014 performs pointer analysis. First, the syntax tree of [6-2] is read in and lines having <dec> tag are retrieved. Based on <node> tags, variables declared as arrays and pointers are detected. In this example, “a” is found to be an array and “b” is to be a pointer in L06. Next, expressions (or lines) to which those variables are assigned are identified. <Stmt> tags between which the variables “a” and “b” are contained range from L16 to L21, and it is understood that assignment operation is performed between the array and the pointer in expression 9 from the fact that the attribute of <node> tag in this range is “=”. By reading in the <r> tag which is the source of assignment, it is found that the index of array “a” is 0. Also, by reading in the <I> tag which is the target of assignment, it is found that the assignment target variable is “b”. Next, based on the variable-address correspondence table 1001 of [6-3], addresses corresponding to those variables are identified. Dependency relation between the addresses (inter-address reference relation data 1015) is finally determined as [6-4] shown below. The assignment target variable is handled as the definition variable and assignment source variable (i.e., called variable) is as the reference variable.

[6-4]

0x0003 -> 0x0000

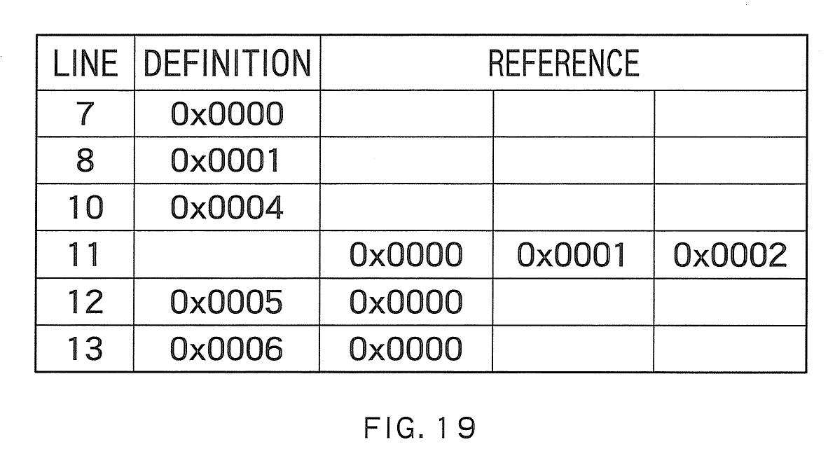

Next, the inter-address definition-reference table (definition-reference data) 1004 shown in FIG. 19 is created by the address definition-reference relation analyzer 1003.

In the expression on the eleventh line of the target program of [6-1], variable “a” is the reference variable and its index is variable “c”. Specifically, the variable “a” is an array and 0 to 2 are declared as its index, the index being specified with a variable. The index starts at 0x0000 from the variable-address correspondence table 1001 of [6-3]. When the reference variable is an array and the index of the array is designated with a variable as in this example, all candidate addresses are extracted into the inter-address definition-reference table (definition-reference data) 1004 as shown in FIG. 19. In this example, 0x0000 for when the index of array variable “a” is 0, 0x0001 for when the index is 1, and 0x0002 for when the index is 2 are the candidate addresses.

While this examples shows a case where the reference variable is an array, all candidate addresses are extracted in a similar manner also when the definition variable is an array and the index of the array is specified with a variable.

In the syntax tree of [6-2], it can be seen from L30 that the index of variable “b” is 0. The address of index 0 of the variable “b” is 0x0003, which corresponds with 0x0000 from the inter-address reference relation data 1015 of [6-4]. Accordingly, the reference address on line 13 in FIG. 19 is 0x0000.

Next, the address dependency relation analyzer 1005 creates the address dependency table 1007 shown below by a similar method to those used in the first to fourth embodiments based on the inter-address definition-reference table (definition-reference data) 1004 of FIG. 19.

[6-5]

DD(7,0x0000,11)
DD(7,0x0000,12)
DD(7,0x0000,13)
DD(8,0x0002,11)
DD(10,0x0002,11)

Next, the control dependency relation analyzer 1006 creates the control dependency table 1008 shown below by a similar method to those used in the first to fourth embodiments.

[6-6]

CD(11,12)
CD(11,13)

Then, a slicing criterion (e.g., a line number) is input from the slicing criterion input unit 1009.

For example, when expression 13 (L13) is selected in the target program of [6-1], the following is extracted as a program fragment (i.e., slice) for expression 13 (L13):

L7: a[0] = 10;
L8: a[1] = 1;
L10: c = 0;
L11: if( a[c] > 10 ){
L13: e = b[0];
}

As described, a program fragment can be correctly extracted also from a target program which has an array variable and in which the index of the array variable is designated with a variable.

What is claimed is:

1. A program analysis apparatus, comprising:
an input unit configured to input
a target program which includes a plurality of statements described by using a plurality of variables and a plurality of operators, the statements each being provided with a line number for identifying each of the statements, each of the variables included in a part of or all of the statements being either a definition variable or a reference variable, and
address definition data which allocates an address to each of the variables;
a first analyzer configured to detect a definition variable and a reference variable in the statements, and generate, for each of the statements including at least one of the definition variable and the reference variable, definition-reference data which associates a line number of the statement, an address allocated to the definition variable included in the statement, and the address allocated to the reference variable included in the statement to each other;
a second analyzer configured to generate address dependency data that associates the address of the definition variable, the line number of the statement that contains the definition variable, and the line number of the statement that contains the reference variable assigned same address as the definition variable to each other, based on the definition-reference data;
a third analyzer configured to detect a control statement and a controlled-object statement which is executed depending on a result of executing the control statement in the target program, and generate control dependency data that associates the line number of the control statement and the line number of the controlled-object statement to each other;
a slicing criterion specifying unit configured to specify a desired line number of a statement in the target program as a slicing criterion; and
a slice extracting unit configured to extract a set of statements which are reached based on the control dependency data and the address dependency data starting from the statement of the desired line number, as a slice from the target program.

2. The apparatus according to claim 1, wherein
at least one variable of the variables is a union having a plurality of members, and the address definition data allocates an address to the union; and
the first analyzer uses the address of the union as the address of each of the members in the union.

3. The apparatus according to claim 1, further comprising
a pointer analyzing unit configured to
detect a assignment statement performing an address operation from among the statements in the target program,
identify a called variable whose address is called in the assignment statement,
identify a assignment target variable into which a result of the address operation based on the called variable is assigned, and
create inter-address reference relation data that maps an address of the assignment target variable to an address of the called variable, wherein
the first analyzer replaces the address of the reference variable that has same address as that of the assignment target variable with the address of the called variable, in the definition-reference data, and
the slice extracting unit extracts the slice further based on the inter-address reference relation data as well as the control dependency data and the address dependency data.

4. The apparatus according to claim 1, further comprising:
an array size analyzing unit configured to detect a statement which declares an array with a variable index from among the statements in the target program and analyze a size of the array in accordance with a detected statement, wherein
for the definition variable or the reference variable which has a form of the array, the first analyzer uses addresses corresponding to all candidate values capable of being taken by the variable index as the address of the definition variable or the reference variable when generating the definition-reference data.

5. The apparatus according to claim 1, wherein
the address definition data is described in the target program.

6. A program analysis method performed in a computer apparatus including a computer readable storage medium containing a set of instructions that cause a computer processor to perform a data analyzing process, comprising:
inputting a target program which includes a plurality of statements described by using a plurality of variables and a plurality of operators, the statements each being provided with a line number for identifying each of the statements, each of the variables included in a part of or all of the statements being either a definition variable or a reference variable,
inputting address definition data which allocates an address to each of the variables;
detecting a definition variable and a reference variable in the statements, and generating, for each of the statements including at least one of the definition variable and the reference variable, definition-reference data which associates a line number of the statement, an address allocated to the definition variable included in the statement, and the address allocated to the reference variable included in the statement to each other;
generating address dependency data that associates the address of the definition variable, the line number of the statement that contains the definition variable, and the line number of the statement that contains the reference variable assigned same address as the definition variable to each other, based on the definition-reference data;
detecting a control statement and a controlled-object statement which is executed depending on a result of executing the control statement in the target program, and generating control dependency data that associates the line number of the control statement and the line number of the controlled-object statement to each other;
specifying a desired line number of a statement in the target program as a slicing criterion; and
extracting a set of statements which are reached based on the control dependency data and the address dependency data starting from the statement of the desired line number, as a slice from the target program.

7. The method according to claim 6, wherein
at least one variable of the variables is a union having a plurality of members, and the address definition data allocates an address to the union; and
the address of the union is used as the address of each of the members in the union when generating the definition-reference data.

8. The method according to claim 6, further comprising
detecting a assignment statement performing an address operation from among the statements in the target program,
identifying a called variable whose address is called in the assignment statement,
identifying a assignment target variable into which a result of the address operation based on the called variable is assigned, and
creating inter-address reference relation data that maps an address of the assignment target variable to an address of the called variable, wherein
the address of the reference variable that has same address as that of the assignment target variable is replaced with the address of the called variable, in the definition-reference data, and
the slice is extracted further based on the inter-address reference relation data as well as the control dependency data and the address dependency data.

9. The method according to claim 6, further comprising:
detecting a statement which declares an array with a variable index from among the statements in the target program and analyzing a size of the array in accordance with a detected statement, wherein
for the definition variable or the reference variable which has a form of the array, addresses corresponding to all candidate values capable of being taken by the variable index are used as the address of the definition variable or the reference variable when generating the definition-reference data.

10. The method according to claim 6, wherein
the address definition data is described in the target program.

11. A program storage medium storing a computer program for causing a computer to execution instructions to perform the steps of:
inputting a target program which describes a plurality of statements by using a plurality of variables and a plurality of operators, the statements each being provided with a line number for identifying each of the statements, each of the variables included in a part of or all of the statements being either a definition variable or a reference variable,
inputting address definition data which allocates an address to each of the variables;
detecting a definition variable and a reference variable in the statements, and generating, for each of the statements including at least one of the definition variable and the reference variable, definition-reference data which associates a line number of the statement, an address allocated to the definition variable included in the statement, and the address allocated to the reference variable included in the statement to each other;
generating address dependency data that associates the address of the definition variable, the line number of the statement that contains the definition variable, and the line number of the statement that contains the reference variable assinged same address as the definition variable to each other, based on the definition-reference data;
detecting a control statement and a controlled-object statement which is executed depending on a result of executing the control statement in the target program, and generating control dependency data that associates the line number of the control statement and the line number of the controlled-object statement to each other;
specifying a desired line number of a statement in the target program as a slicing criterion; and
extracting a set of statements which are reached based on the control dependency data and the address dependency data starting from the statement of the desired line number, as a slice from the target program.
